(19) United States
(12) Patent Application Publication
(10) Pub. No.: US 2009/0113144 A1
(43) Pub. Date: Apr. 30, 2009

(54) ELECTRONIC DEVICE AND METHOD OF CONTROLLING THE SAME

(75) Inventor: Tomoaki Tokunaga, Ome-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/238,296

(22) Filed: Sep. 25, 2008

(30) Foreign Application Priority Data
Oct. 31, 2007 (JP) 2007-284097

(51) Int. Cl. G06F 13/00

(52) U.S. Cl. 711/154; 711/E12.001

(57) ABSTRACT

According to one embodiment, an electronic device includes a main memory, a main controller which controls the main memory, a system BIOS which stores default access parameter data of the main memory, a substrates including a memory device installing region in which the main memory and a memory device storing other access parameter data of the main memory are to be installed, and a setting section which sets, when a memory device is installed in the memory device installing region, access parameter data read out from the memory device to the memory controller, and sets, when a memory device is not installed in the memory element region, access parameter data read out from the system BIOS to the memory controller.

### CROSS-REFERENCE TO RELATED APPLICATIONS

This application is based upon and claims the benefit of priority from Japanese Patent Application No. 2007-284097, filed Oct. 31, 2007, the entire contents of which are incorporated herein by reference.

### BACKGROUND

1. Field

One embodiment of the present invention relates to an electronic device on which an SPD memory can be installed, and more specifically to an electronic device which can select installation or non-installation of an SPD memory and its controlling method.

2. Description of the Related Art

Generally, in a memory module initialization method, a default access parameter for an installed memory is read out from BIOS and it is set to a memory controller. Further, in a built-in type system, a serial presence detect (SPD) read-only memory (ROM) is installed as disclosed in, for example, Jpn. Pat. Appln. KOKAI Publication No. 2004-145733. This document discloses the following technique. That is, in the case where the default access parameter pre-stored in the BIOS of the system is not able to follow, for example, by upgrading of the main memory, an access parameter of the main memory after the upgrading is read out from the SPD, and set to the memory controller. (See Jpn. Pat. Appln. KOKAI Publication No. 2004-145733.)

However, in the technology disclosed in Jpn. Pat. Appln. KOKAI Publication No. 2004-145733, SPD is always installed, and therefore this technique results in an increase in cost when an SPD is not necessary.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram schematically showing the structure of an electronic device according to an embodiment of the present invention as an exemplary.

FIG. 2 is an exemplary flowchart which explains a controlling method used in the embodiment as an exemplary.

FIG. 3 is an exemplary diagram showing a technical concept in the case where a memory device such as an SPD is not installed in a memory device installing region in the embodiment as an exemplary.

FIG. 4 is an exemplary diagram showing a technical concept in the case where a memory device such as an SPD is installed in a memory device installing region in the embodiment as an exemplary.

### DETAILED DESCRIPTION

Various embodiments according to the invention will be described hereinafter with reference to the accompanying drawings. In general, according to one embodiment of the invention, an electronic device comprising: a main memory; a main controller which controls the main memory; a system BIOS which stores default access parameter data of the main memory; a substrates including a memory device installing region in which the main memory and a memory device storing other access parameter data of the main memory are to be installed; and a setting section which sets, when a memory device is installed in the memory device installing region, access parameter data read out from the memory device to the memory controller, and sets, when a memory device is not installed in the memory element region, access parameter data read out from the system BIOS to the memory controller.

An embodiment of the present invention will now be described with reference to accompanying drawings.

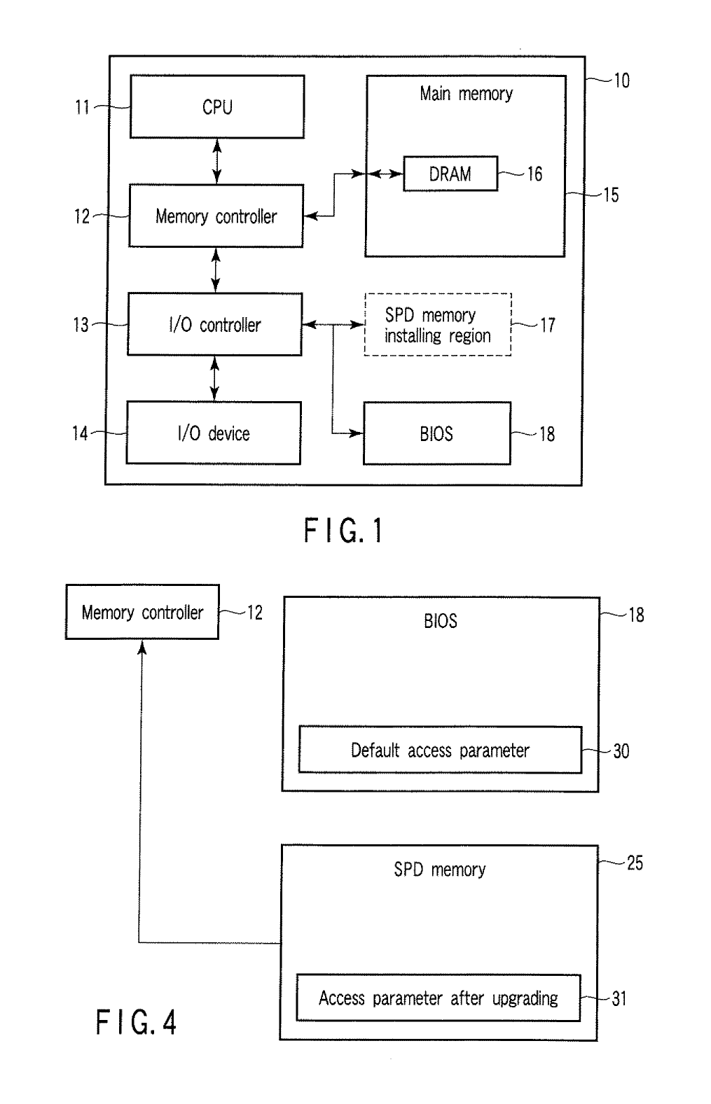

First, an electronic device according to an embodiment of the present invention will be described with reference to FIG. 1.

FIG. 1 is a block diagram schematically showing the structure of an electronic device according to the embodiment of the present invention. An electronic device 10 includes a CPU 11, a memory controller 12, an I/O controller 13, an I/O device 14, a main memory 15, a serial presence detect (SPD) RON installing region 17 and a (system) BIOS-ROM 18. It should be noted that a dynamic random access memory (DRAM) 16, for example, is employed as the main memory 15.

The CPU 11 sets a read-out access parameter to the memory controller 12, and further judges whether or not a memory device is installed in the memory device installing region 17. The memory controller 12 is a bridge controller which bridges the main memory 15, the main memory 15 and the I/O controller 13. The memory controller 12 includes an interface for the main memory 15, and carries out DRAM control (access) after setting the access parameter of the DRAM 16 to the internal register. Here, the access parameter (spec data) is equivalent to the contents (such as Row/Column address size and the like) of serial presence detect (SPD) prescribed by Joint Electron Device Engineering Council (JEDEC). It should be noted that the default DRAM access parameter (spec data) is read out from the BIOS-ROM 18 when the system is booted up.

The I/O controller is connected to the memory controller 12 and thus it interfaces with I/O devices of the downstream. The I/O device 14 is, for example, a hard disk drive (HDD). In this embodiment, it is the on-board DRAM 16. Note that there may be a plurality of DRAMS 16 installed.

The SPD (ROM) is a non-volatile memory which stores the DRAM access parameter, and it is equivalent to an SPD in a dual inline memory module (DIMM). In this embodiment, it is not necessary to install an SPD as long as the DRAM is not changed or replaced. In other words, the embodiment is able to select whether or not an SPD is installed. Thus, the installation of an SPD memory is not essential here. In the case where the DRAM is changed or replaced by, for example, upgrading, the DRAM access parameter after the upgrading is stored in the SPD. Further, the SPD is installed in the SPD (ROM) installing region 17. Note that the SPD (ROM) installing region 17 is a region reserved on the board regardless of whether or not an SPD is installed.

The BIOS-ROM 18 is a ROM which stores BIOS codes, and it stores the default DRAM access parameter. Here, it is not necessary to install an SPD memory unless the DRAM is changed or replaced, and in usual cases (where the DRAM is not changed or replaced), the default DRAM access parameter is read out from the BIOS-ROM 18 when it is used.

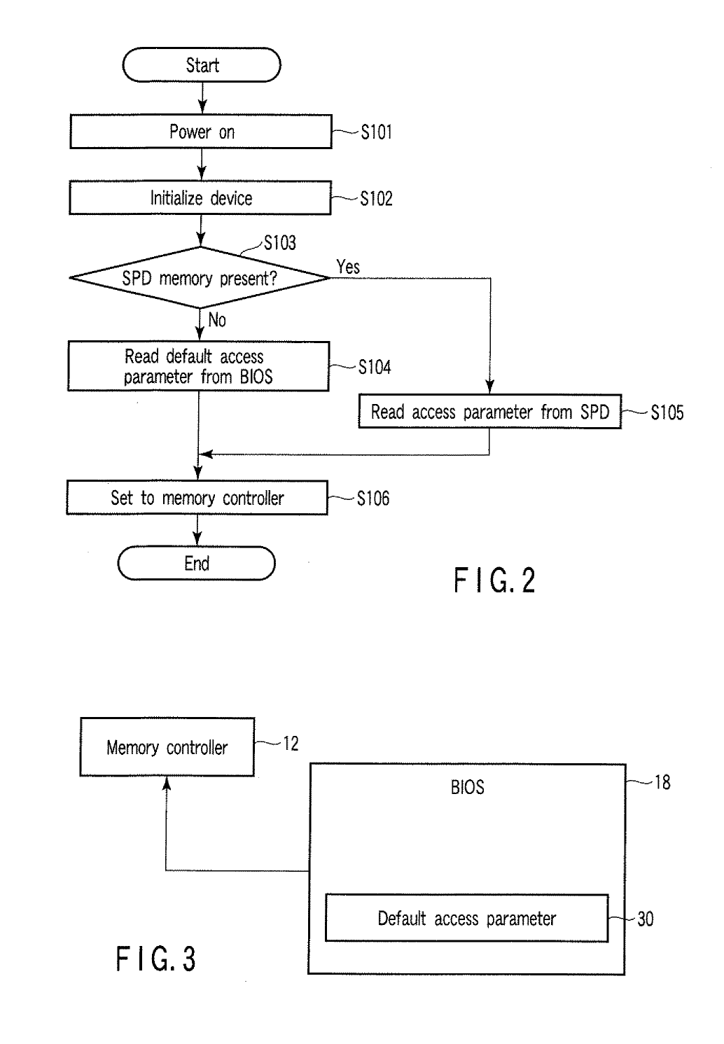

Next, a controlling method used in an electronic device according to the embodiment of the present invention will now be described with reference to the flowchart shown in FIG. 2.

When the power of the electronic device 10 is turned on (Block S101), the memory controller 12, and the other devices are initialized (Block S102). The CPU 11 judges whether or not a memory device such as an SPD is installed in the memory device installing region 17 (Block 5103). When the CPU 11 judges that a memory device such as an SPD is not installed in the memory device installing region 17 (NO in Block S103), the default DRAM access parameter 30 (see FIG. 3) which is pre-stored in the BIOS-ROM 18 is read out (Block S104). Then, the CPU 11 sets the read-out DRAM access parameter to the memory controller 12 (Block S106: see FIG. 3).

On the other hand, when the CPU 11 judges that a memory device such as an SPD is installed in the memory device installing region 17 (YES in Block S103), the DRAM access parameter 31, which is pre-stored in the SPD is read out (Block S105). Then, the CPU 11 sets the read-out DRAM access parameter to the memory controller 12 (Block S106: see FIG. 4).

It should be noted that in the case where a memory device such as an SPD is installed in the memory device installing region 17, which is such a case where the DRAM is changed or replaced by, for example, upgrading, the DRAM access parameter after the upgrading is pre-stored in the SPD, and the stored upgraded DRAM access parameter is read out from the SPD and set to the memory controller 12. Thus, the DRAM after the upgrading can be controlled.

As described above, according to the embodiment, an SPD can be installed only when it is necessary. In other words, when the DRAM is not changed or replaced, it is possible to select such a state that a memory device such as an SPD is not installed, and therefore the cost can be reduced by that of the SPD.

It should be noted that the present invention is not limited directly to the above-described embodiment as it is, but in the present invention, its structural elements can be changed, when the invention is actually embodied, as long as the essence of the invention falls within its scope.

Under these circumstances, an object of the present invention is to provide an electronic device which can install an SPD only when it is necessary, and a controlling method employed in such a device.

Further, a plurality of structural elements discussed in the above-described embodiment can be combined in various ways when needed, which result in various versions of the invention. For example, some of the structural elements discussed in the embodiment may be deleted. Furthermore, structural elements of various embodiments may be combined together when needed.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An electronic device comprising:
a main memory;
a main controller which controls the main memory;
a system BIOS which stores default access parameter data of the main memory;
a substrates including a memory device installing region in which the main memory and a memory device storing other access parameter data of the main memory are to be installed; and
a setting section which sets, when a memory device is installed in the memory device installing region, access parameter data read out from the memory device to the memory controller, and sets, when a memory device is not installed in the memory element region, access parameter data read out from the system BIOS to the memory controller.

2. The electronic device according to claim 1, wherein the memory device is a ROM which stores spec data of the main memory.

3. The electronic device according to claim 1, wherein the memory device is an SPD which stores spec data of the main memory.

4. The electronic device according to claim 1, wherein the main memory is of a built-in type which is pre-installed on the substrate.

5. A controlling method to be employed in an electronic device including a main memory, a main controller which controls the main memory, a system BIOS which stores default access parameter data of the main memory, and a substrates including the main memory and a memory device installing region for storing other access parameter data of the main memory, the method comprising:
setting, when a memory device is installed in the memory device installing region, access parameter data read out from the memory device to the memory controller; and
setting, when a memory device is not installed in the memory element region, access parameter data read out from the system BIOS to the memory controller.

6. The controlling method according to claim 5, wherein the memory device is a ROM which stores spec data of the main memory.

7. The controlling method according to claim 5, wherein the memory device is an SPD which stores spec data of the main memory.

8. The controlling method according to claim 5, wherein the main memory is of a built-in type which is pre-installed on the substrate.
